(19) United States
(12) Patent Application Publication
(10) Pub. No.: US 2003/0204659 A1
(43) Pub. Date: Oct. 30, 2003

(54) Digital storage media with one-time programmable read only memory

(76) Inventor: Kan-Chuan Huang, Tao-Yuan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,447

(22) Filed: Apr. 24, 2002

(51) Int. Cl. G06F 13/14

(52) U.S. Cl. 710/305

(57) ABSTRACT

A digital storage media connects to an electronic device for storing digital data transmitted from the electronic device. The digital storage media includes an interface control circuit for controlling interface between the electronic device and the digital storage media, a first memory for storing program codes of the digital storage media, and a second memory for storing digital data transmitted from the electronic device. The digital storage media also includes a memory control circuit electrically connected between the interface control circuit and the second memory for storing the digital data transmitted from the interface control circuit into the second memory, and a processor for controlling operations of the digital storage media. For storing the digital data transmitted from the electronic device, the second memory has metal-insulator-semiconductor transistors.

### BACKGROUND OF INVENTION

1. Field of the Invention

The present invention relates to an electronic device for storing digital data, and more specifically, to an electronic device that uses one-time programmable read only memory for storing digital data.

2. Description of the Prior Art

As the consumer electronics market continues to grow, an increasing number of electronic products are utilizing non-volatile memory for storing digital information. Currently, products such as digital still cameras, personal digital assistants, digital picture frames, and cellular phones typically make use of flash memory to store digital information. Flash memory provides a means for the electronic product to store information in a non-volatile manner. For example, a digital still camera can use flash memory as digital film for storing digital images taken by the camera. However, the use of flash memory has several disadvantages.

The use of MIS as a memory device is taught in U.S. patent application Ser. No. 10/055,047, “Low voltage single-poly Flash memory cell and array”, which has a filing date of Jan. 25, 2002. In this application, non-volatile memory cell structures are compared with MOS memory cell structures.

Please refer to FIG. 1 . FIG. 1 is a schematic diagram of a flash memory cell 10 according to the prior art. The flash memory cell 10 contains a substrate 20 with doped regions 18. Dielectric material 24 is then formed on the substrate 20. Through a complicated series of masking and etching processes, a section of dielectric material 24 that contains a contact gate 14 and a floating gate 16 is separated from other portions of the dielectric material 24. As a result of etching processes, contact holes 22 are formed on the left and right sides of the contact gate 14 and the floating gate 16. The flash memory cell 10 contains two poly-silicon layers in which the contact gate 14 and the floating gate 16 are formed.

Please refer to FIG. 2. FIG. 2 is a schematic diagram of a metal insulator semiconductor (MIS) memory cell 30 according to the prior art. Like the flash memory cell 10 shown in FIG. 1, the MIS memory cell 30 contains a substrate 40 with doped regions 38. Dielectric material 45 is formed on the substrate 40. The dielectric material 45 can be a single charge-trapping material and also can be a composite dielectric layer such as oxide-nitride-oxide layers. A section of dielectric material 44 containing a control gate 36 is separated from other portions of the dielectric material 44 by contact holes 42 on the left and right sides of the control gate 36. Unlike the flash memory cell 10, the MIS memory cell 30 contains only one poly-silicon layer. Thus, the MIS memory cell 30 only has the control gate 36 and does not have a floating gate.

Since the structures of the flash memory cell 10 and the MIS memory cell 30 are different, the manufacturing processes of each differ in many ways. First of all, the flash memory cell 10 contains two poly-silicon layers instead of one like the MIS memory cell 30. To form this more complicated structure, six to eight additional masking steps are needed when making flash memory. In addition, a greater amount of other processes such as etching are needed for flash memory manufacturing compared to MIS memory manufacturing. Due to the relative complexity, flash memory manufacturing costs are much higher than MIS memory manufacturing costs. Therefore, electronic products that use flash memory also have high costs.

### SUMMARY OF INVENTION

It is therefore a primary objective of the claimed invention to provide a digital storage media with one-time programmable read only memory (OTPROM) to solve the above-mentioned problems.

According to the claimed invention, an electronic device connects to a digital storage media for storing digital data transmitted from the electronic device. The digital storage media include an interface control circuit for controlling interface between the electronic device and the digital storage media, a first memory for storing program codes of the digital storage media, and a second memory for storing digital data transmitted from the electronic device. The digital storage media also includes a memory control circuit electrically connected between the interface control circuit and the second memory for storing the digital data transmitted from the interface control circuit into the second memory, and a processor for controlling operations of the digital storage media. For storing the digital data transmitted from the electronic device, the second memory has metal-insulator-semiconductor transistors.

It is an advantage of the claimed invention that the second memory uses metal-insulator-semiconductor transistors for reducing the cost of the electronic device.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic diagram of a flash memory cell according to the prior art.

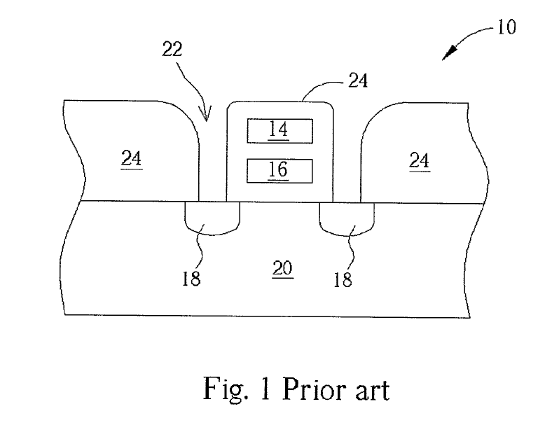

FIG. 2 is a schematic diagram of a metal insulator semiconductor memory cell according to the prior art.

FIG. 3 is a block diagram of a digital storage media according to the present invention.

### DETAILED DESCRIPTION

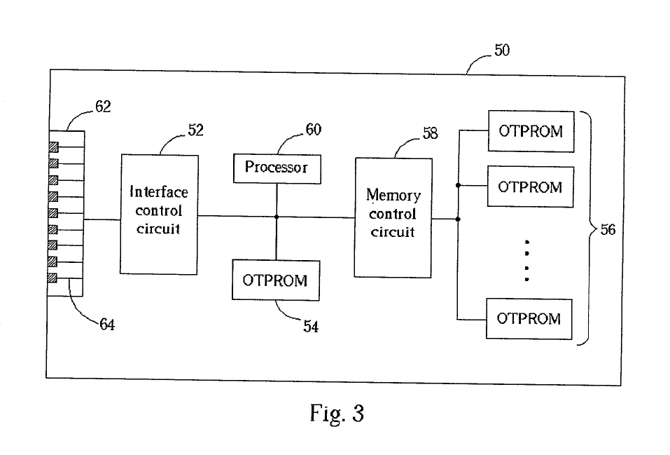

Please refer to FIG. 3. FIG. 3 is a block diagram of a digital storage media 50 according to the present invention. The digital storage media 50 can be connected to an electronic device for storing digital data transmitted from the electronic device. The digital storage media 50 comprise an interface control circuit 52 for controlling interface between the electronic device and the digital storage media 50, a first memory 54 for storing program codes of the digital storage media 50, and a second memory 56 for storing digital data transmitted from the electronic device. Both the first memory 54 and the second memory 56 are one-time programmable read only memory (OTPROM), and can be made with any semiconductor technology such as p-channel MOS (PMOS), n-channel MOS (NMOS), or complementary MOS (CMOS). The digital storage media 50 also comprise a memory control circuit 58 electrically connected between the interface control circuit 52 and the second memory 56 for storing the digital data transmitted from the interface control circuit 52 into the second memory 56. A processor 60 is used to control operations of the digital storage media 50. For receiving digital signals transmitted from the electronic device, the digital storage media 50 uses a secure digital interface 62. The secure digital interface 62 has a plurality of gold fingers 64 electrically connected to the interface control circuit 52 for receiving the electrical signals from any electronic device that uses a secure digital interface.

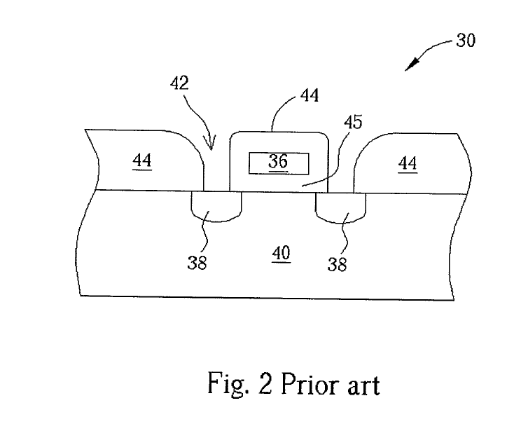

The first memory 54 and second memory 56 of the digital storage media 50 are made with MIS transistors using a single poly-silicon layer, like the MIS memory cell 30 shown in FIG. 2. As mentioned above, the first memory 54 and the second memory 56 each form an OTPROM structure. Since the first memory 54 holds program code of the digital storage media 50, an OTPROM structure is perfectly suited for this function since the program code will only be written once to the digital storage media 50. Likewise, since the second memory 56 holds digital data transmitted from the electronic device, an OTPROM structure allows the digital data to be permanently stored, without the risk of accidental erasure.

All of the circuitry on the digital storage media 50 such as the processor 60, the memory control circuit 58, and the interface control circuit 52 is made from MOS transistors. Since the first memory 54 and the second memory 56 can be also made from same technology, the digital storage media 50 can be built using a single chip. As previously mentioned, manufacturing MIS memory costs much less than manufacturing flash memory.

Compared to the prior art, the present invention digital storage media uses MIS memory to form an OTPROM memory structure. By using MIS memory instead of flash memory, significant cost savings are realized, and the digital storage media provides permanent storage for digital data.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A digital storage media connected to an electronic device for storing digital data transmitted from the electronic device comprising:
an interface control circuit for controlling interface between the electronic device and the digital storage media;
a first memory for storing program codes of the digital storage media;
a second memory for storing digital data transmitted from the electronic device;
a memory control circuit electrically connected between the interface control circuit and the second memory for storing the digital data transmitted from the interface control circuit into the second memory; and
a processor for controlling operations of the digital storage media;
wherein the second memory comprises metal oxide transistors for storing the digital data transmitted from the electronic device.

2. The digital storage media of claim 1 being formed on a chip.

3. The digital storage media of claim 1 wherein the second memory is one-time programmable read only memory.

4. The digital storage media of claim 1 wherein the metal oxide transistors are p-type metal-insulator-semiconductor transistors.

5. The digital storage media of claim 1 wherein the metal oxide transistors are n-type metal-insulator-semiconductor transistors.

6. The digital storage media of claim 1 wherein each metal-insulator-semiconductor transistor comprises only one single poly-silicon layer.

7. The digital storage media of claim 1 wherein the first memory is one-time programmable read only memory.

8. The digital storage media of claim 6 wherein the first memory comprises metal-insulator-semiconductor transistors for storing the program codes.

9. The digital storage media of claim 7 wherein the metal-insulator-semiconductor transistors of the first memory are p-type metal-insulator-semiconductor transistors.

10. The digital storage media of claim 7 wherein the metal-insulator-semiconductor transistors of the first memory are n-type metal-insulator-semiconductor transistors.

11. The digital storage media of claim 7 wherein each metal-insulator-semiconductor transistor of the first memory comprises only one single poly-silicon layer.

12. The digital storage media of claim 1 further comprising one of Compact Flash, Smart Media, Multi-Media Card, Secure Digital, or Memory Stick interface electrically connected to the interface control circuit for receiving the digital signals transmitted from the electronic device.

13. The digital storage media of claim 1 wherein the electronic device is a digital still camera.

14. The digital storage media of claim 1 wherein the electronic device is a personal data assistant.

15. The digital storage media of claim 1 wherein the electronic device is a cellular phone.

16. The digital storage media of claim 1 wherein the electronic device is a digital picture frame.

17. The digital storage media of claim 1 wherein the electronic device is a digital audio player.

18. The digital storage media of claim 1 wherein the electronic device is a game device.

19. A device with flexible capacity for storing picture images, not limited to 24 or 36 pictures as with traditional film.
